(19) United States
(12) Patent Application Publication
(10) Pub. No.: US 2023/0192291 A1
(43) Pub. Date: Jun. 22, 2023

(54) PROVISIONING, COMMUNICATING AND IMPLEMENTING SANCTIONED COMMERCIAL DRONE FLIGHTS

(71) Applicant: John Svolos, Chicago, IL (US)

(72) Inventor: John Svolos, Chicago, IL (US)

(21) Appl. No.: 17/558,530

(22) Filed: Dec. 21, 2021

(51) Int. Cl. B64C 39/02; G05D 1/10; G01C 21/20; G01S 19/01

(52) U.S. Cl. CPC B64C 39/024; G05D 1/106; G01C 21/20; G01S 19/01; B64C 2201/027; B64C 2201/145

(57) ABSTRACT

The following relates generally to determining, provisioning, communicating, and implementing flight paths for drones. The flight path may include a cross section that the drone is required to stay within while traveling through the flight path. Some implementations enable the safe and sustainable use of growing volumes of commercial drone traffic by incorporating public policy into a system that protects public health and safety, and facilitates collection of fees.

### FIELD OF THE DISCLOSURE

The following relates to systems and methods for provisioning, communicating and implementing sanctioned flight paths for commercial drones.

### BACKGROUND

The growing use of commercial drones in cities and towns poses problems, such as creating a public nuisance, congestion of drone traffic, threats to public health or safety, and expense of managing and regulating drone traffic.

A process currently does not exist that provisions a safe flight path to drones through publicly sanctioned right-of-way. For example, although collision avoidance systems currently exist in drones, they are not sufficient to solve the problems associated with increasing drone traffic, particularly commercial drone traffic. Current collision avoidance systems do not take into account rules and regulations regarding time, place and location of drone traffic. Nor is it sufficient to rely on collision avoidance to protect public safety, as other factors (e.g., weather) can cause drones to crash. Nor does collision avoidance provide for assessing fees for use of commercial drones.

The systems and methods disclosed herein provide solutions to these problems and others, enabling the safe and sustainable use of growing volumes of drone traffic by incorporating public policy into a system that protects public health and safety, and facilitating the collection of fees.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one aspect, a computer-implemented method for generating a flight path of a drone may be provided. The method may comprise: (1) receiving, with one or more processors, drone information including technical information of the drone, and a proposed payload of the drone; (2) receiving, with the one or more processors, proposed flight path information including a proposed start location, and a proposed end location; (3) generating, with the one or more processors, a cross section of the flight path based on the technical information of the drone, and the proposed payload of the drone; (4) generating, with the one or more processors, the flight path based on the proposed start location, and the proposed end location; and (5) sending, with the one or more processors, the flight path and the cross section of the flight path to the drone.

In another aspect, a device for generating a flight path of a drone may be provided. The device may comprise one or more processors configured to: (1) receive: (i) topological information of a geographic area, and (ii) regulatory information of the geographic area; (2) receive proposed flight path information including a proposed start location, and a proposed end location; (3) generate the flight path of the drone based on: (i) the proposed start location, (ii) the proposed end location, (iii) the topological information, and (iv) the regulatory information of the geographic area; and (4) send the generated flight path to the drone.

In yet another aspect, a drone may be provided. The drone may comprise: a drone body; a plurality of propulsion devices connected to the drone body; and a drone transmitter, and a drone receiver comprised in the drone body. The drone may further comprise one or more drone processors configured to: (1) send, via the drone transmitter, drone information including technical information of the drone, and a proposed payload of the drone; (2) send, via the drone transmitter, proposed flight path information including a proposed start location, and a proposed end location; (3) receive, via the drone receiver, a cross section of a flight path, wherein the cross section of the flight path was generated based on the technical information of the drone, and the proposed payload of the drone; (4) receive, via the drone receiver, the flight path, wherein the flight path was generated based on the proposed start location, and the proposed end location; and (5) control, via the plurality of propulsion devices, the drone to fly: (i) according to the received flight path, and (ii) within the received cross section of the flight path.

The systems and methods disclosed herein advantageously provide drones with safe travel routes. For instance, the systems and methods described herein reduce the risk of drones colliding with each other and/or other objects.

A further advantage of the systems and methods disclosed herein is to provide efficiency in determining drone routes, particularly commercial drone routes, thus improving the speed at which goods may be delivered via drones.

### BRIEF DESCRIPTION OF THE DRAWINGS

FIG. 1 illustrates an example system for determining a flight path and/or a cross section of the flight path.

FIG. 2 illustrates an example drone.

FIG. 3 illustrates example flight paths.

FIG. 4 illustrates an example flight path cross section which is circular.

FIG. 5 illustrates an example flight path cross section which is noncircular.

FIG. 6 is a 3-dimensional (3D) illustration of an example of a drone in a virtual tube.

FIGS. 7A and 7B illustrate an example method of determining a flight path and a cross section of the flight path. FIG. 7B is a continuation of the example method illustrated in FIG. 7A.

FIG. 8 illustrates another example method of determining a flight path and a cross section of the flight path.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### DETAILED DESCRIPTION

The present embodiments relate to systems and methods for provisioning, communicating and implementing sanctioned flight paths for drones. Some embodiments enable the safe and sustainable use of growing volumes of commercial drone traffic by incorporating public policy into a system that protects public health and safety and facilitates collection of fees.

As stated above, the growing use of commercial drones in cities and towns poses problems, such as creating a public nuisance, congestion of drone traffic, threats to public health or safety, and expense of managing and regulating drone traffic. The systems and methods described herein solve these problems and others.

The techniques described herein establish a process which facilitates multiple and simultaneous drone flights safely through publicly sanctioned flight space. For example, some embodiments establish a process to define and allocate flight-specific right-of-way in the form of a virtual tube through publicly sanctioned flight space at publicly sanctioned dates and times, thereby enabling regulation and taxation of authorized and safe drone flights. As used herein, “virtual tube” refers to a flight path having a cross section. Further as used herein, unless specified otherwise, “cross section” refers to the cross section of the flight path or virtual tube.

Some embodiments provision a virtual tube through space for each drone flight or establish a dedicated virtual tube exclusive to a particular repeated use.

Some implementations may establish the dimensions of the virtual tube through space based on the capabilities of specific drone models to adhere to the determined virtual tube in various weather conditions and based on a specified margins of safety. In some embodiments, the virtual tube is cylindrical; however the virtual tube may be any shape. For example, the virtual tube (e.g., flight path) may have a cross section that is oval, elliptical, rectangular, or curved on some edges while flat on others, etc.

In this regard, some embodiments monitor and record drone flights, and track adherence to the flight safety guidelines, including adherence to the flight path and/or cross section of the flight path.

Furthermore, some embodiments assess fees on drone users for flights and/or for use of flight space.

The claimed invention differs from what currently exists. No system exists facilitating ad hoc point-to-point allocation of air space to drones. For example, the advent of commercial drones is relatively new, and the volume of commercial drone traffic is growing, driving the need for organized, regulated and safe use. Some embodiments are uniquely applicable to that emerging use case. They anticipate public rules and regulations around drone use, such as restrictions over time and date of flight or prohibitions of flights over certain zones, such as over schools, hospitals or homes. They provide for planning and enforcement of safe flight routes. They provide for fees for use of drones. And they specifically accommodate the technical ability of any drone to stay on course by adjusting the course and dimensions of the flight path and/or cross section of the flight path to provide for deviation within a margin of safety.

Some embodiments include a system for planning and executing any drone (including commercial drones) service by users, enabling users to adhere to standards, rules or regulations relating to safe and sanctioned use of drones. The system may facilitate logistics relating to commercial drones, enabling drone users to operate services requiring drones to pass safely and legally through public space.

Some embodiments comprise establish property rights relating to sanctioned paths, whereby a commercial drone service may purchase rights to a given path from the applicable jurisdictional authorities.

Furthermore, some embodiments may comprise a basis of establishing navigational protocols used by drone users, whether manual or autonomous, and may comprise a basis for standardization of drone navigational protocols. The protocols may enable drone users to incorporate the dimensions of the sanctioned path into navigational systems, and enable tracking and recording of the flight.

### Example System

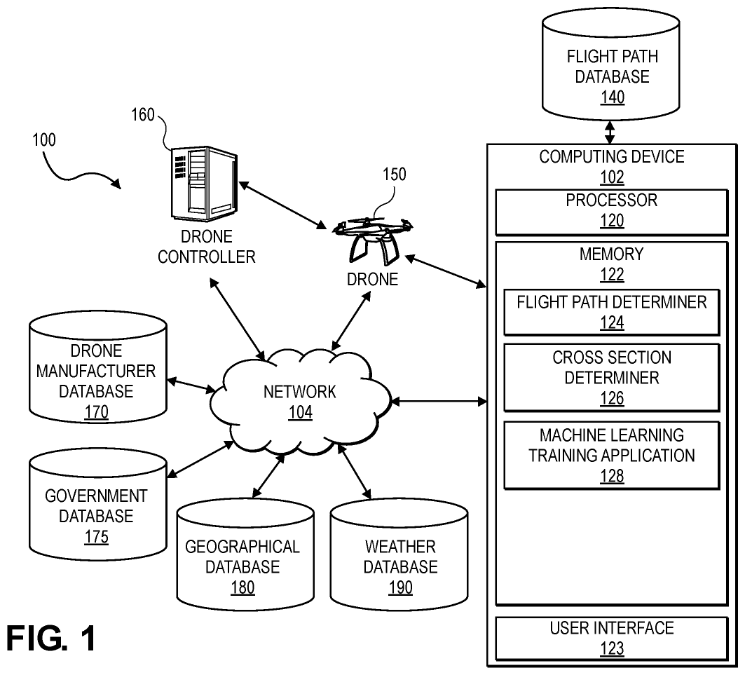

FIG. 1 shows an example system 100 for determining a flight path and/or a cross section of the flight path. The high-level architecture illustrated in FIG. 1 may include both hardware and software applications, as well as various data communications channels for communicating data between the various hardware and software components, as is described below. The system may include a computing device 102 configured to communicate (e.g., via a network 104, which may be a wired or wireless network, such as the internet), with drone 150, drone controller 160, drone manufacturer database 170, government database 175, and/or geographical database 180.

The computing device 102 may include one or more processors 120 such as one or more microprocessors, controllers, and/or any other suitable type of processor. The computing device 102 may further include a memory 122 (e.g., volatile memory, non-volatile memory) accessible by the one or more processors 120 (e.g., via a memory controller). Additionally, the computing device may include a user interface 123.

The one or more processors 120 may interact with the memory 122 to obtain, for example, computer-readable instructions stored in the memory 122. Additionally or alternatively, computer-readable instructions may be stored on one or more removable media (e.g., a compact disc, a digital versatile disc, removable flash memory, etc.) that may be coupled to the computing device 102 to provide access to the computer-readable instructions stored thereon. In particular, the computer-readable instructions stored on the memory 122 may include instructions for executing various applications, such as, a flight path determiner 124, an cross section determiner 126, and/or a machine learning training application 128. The computing device 102 may further be in communication with a flight path database 140 for storing drone information, flight path information, cross section information, etc.

The drone 150 may be any kind of drone (e.g., a commercial drone, a governmental drone, a drone owned by a private citizen, etc.). The drone 150 may be configured to communicate with the drone controller 160 and/or the computing device 102 through the network 104. Additionally or alternatively, the drone 150 may be configured to communicate with the drone controller 160 and/or the computing device 102 directly by any other suitable technique (e.g., through radio waves, for example, using a transmitter and/or receiver controlled by the computing device 102).

The drone controller 160 may be any device suitable to communicate with and/or control the drone 150. For example, the drone controller may be a device (e.g., one or more processors, one or more servers, etc.) that is part of an operational center for controlling drones (e.g., of a delivery company that controls a drone fleet, etc.). Additionally or alternatively, the drone controller 160 may be a dedicated device whose primary and/or only function is to control the drone 150. Additionally or alternatively, the drone controller 160 may be a server, personal computer, a tablet, a smart phone, a phablet, etc. Additionally or alternatively, as in the example of FIG. 1, the drone 150 may be controlled by a fully automated process, and require no (or very little) human supervision/interaction (e.g., the drone controller 160 is part of an operational center, etc.); however, in some embodiments, the drone controller 160 may be controlled by a human.

The drone manufacturer database 170 may include any information relating to drones. For example, the information included in the manufacturer database 170 may include make and model of drones, technical specifications of drones, cost of drones or drone parts, warranty information, recall information, etc. Furthermore, although the example of FIG. 1 illustrates only one drone manufacturer database 170, any number of drone manufacturer databases may be used.

The government database 175 may include any information. For example, the information included in the government database 175 may include government regulations of drones, government regulations of airspace, recommended flight paths, required margins of error for flight paths, required minimum cross sections of flight paths, geographic information of no fly zones (e.g., drones not allowed to fly over hospitals, schools, etc.), regulations regarding weather or predicted weather, etc. Furthermore, although the example of FIG. 1 illustrates only one government database 170, any number of government databases may be used (e.g., a federal database, a state database, a local government database, etc.).

The geographical database 180 may include any information. For example, the information stored in the geographical database 180 may include geographic information, topological information (e.g., building heights/dimensions, power line heights/dimensions, natural land heights/dimensions, etc.), zoning information, etc. Furthermore, although the example of FIG. 1 illustrates only one geographical database 180, any number of geographic databases may be used.

The weather database 190 may include any information. For example, the information stored in the weather database 190 may include current weather information, predicted weather information, predicted natural disaster information, etc. Furthermore, although the example of FIG. 1 illustrates only one weather database 190, any number of weather databases may be used.

### Example Drone

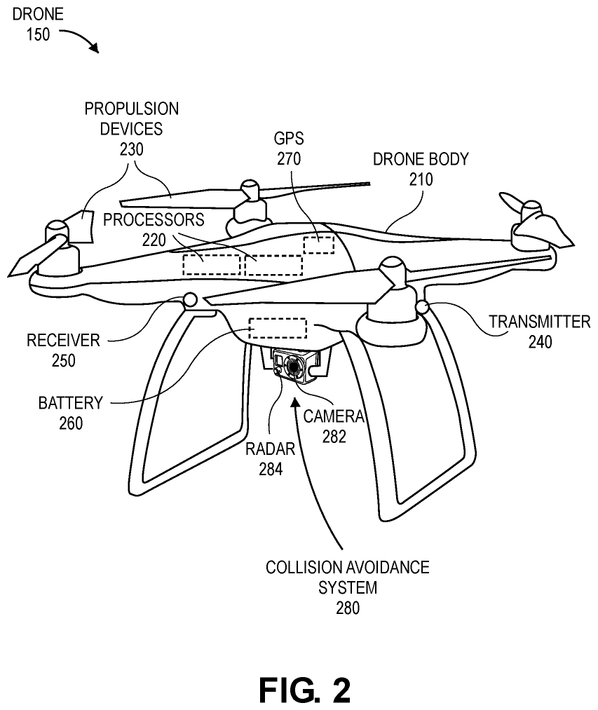

FIG. 2 illustrates an example drone 150. With reference thereto, the drone body 210 may be made of any suitable material, such as metal, plastic, or combinations thereof.

The one or more drone processors 220 may perform any suitable function, such as controlling the propulsion devices 230 to thereby control the flight of the drone 150. Although the example of FIG. 2 illustrates the propulsion devices 230 as propellers, it may be noted that the propulsion devices 230 may comprise any suitable component(s). For example, the propulsion devices 230 may comprise impellers or any component(s) capable of flying and/or maneuvering the drone 150.

The one or more drone processors 220 may further control the transmitter 240 and the receiver 250 (e.g., to communicate with the network 104, the drone controller 160, and/or the computing device 102). The drone 150, including all components discussed herein, may be powered by the battery 260.

The global positioning system (GPS) 270 may determine a location of the drone 150, which may be communicated to any suitable component (e.g., computing device 102 and/or drone controller 160) through the transmitter 240.

The collision avoidance system 280 may be used to prevent the drone 150 from colliding with other drones or objects. The collision avoidance system may include camera 282, which may be a photographic camera, a light detection and ranging (LIDAR) camera, etc. The collision avoidance system 280 may further include radio detection and ranging (RADAR) 284. The camera 282 and/or RADAR 284 may be used to measure the distance between the drone 150 and other drones and/or objects.

It should be understood that FIG. 2 illustrates an example, and is not restrictive. For instance, the drone 150 may include additional, fewer, or alternative components to those illustrated in the example of FIG. 2.

### Example Flight Paths

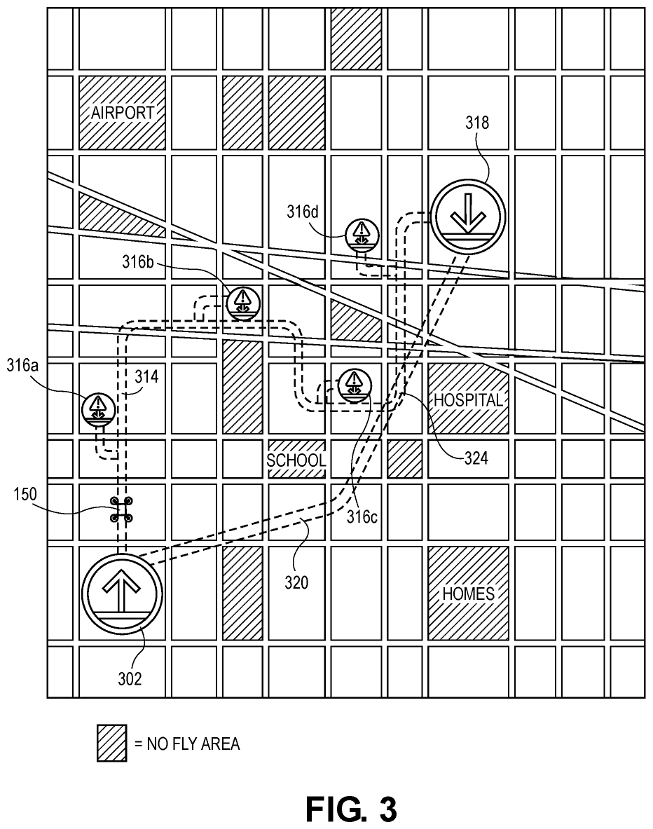

FIG. 3 illustrates example flight paths 314, 320 (e.g., generated by the computing device 102). The drone 150 following either of the flight paths 314, 320 may begin at start location (e.g., launch site) 302, and end at end location (e.g., landing site) 318. The flight paths 314, 320 further avoid the no fly areas (e.g., including the hospital, school, homes, and airport). No fly areas (e.g., no fly zones) may also include residential zones and/or protected zones. In some embodiments, the no fly zones are always no fly zones. However, in other embodiments, areas may be designated as no fly zones only during particular time periods (e.g., specific times of day and week). As such, the computing device 102 may make a determination as to if the no fly zone is applicable during the time window for the drone 150 to travel along the flight path.

The example flight path 314 is generated in part based on minimizing distances to emergency landing sites 316a, 316b, 316c, 316d. On the other hand, the example flight path 320 is not generated based on minimizing a distance to the emergency landing sites 316a, 316b, 316c, 316d.

Furthermore, the two flight paths 314, 320 intersect in longitude and latitude at location 324. In some embodiments, at this intersect location 324, the computing device 102 will avoid collision of drones on the flight paths 314, 320 by making altitudes of the flight paths 314, 320 different from each other. In some embodiments, this may be accomplished by determining which drone on the flight paths 314, 320 has a lighter payload (or proposed payload), and making the drone with the lighter payload take the higher altitude flight path. The altitude of the flight paths may be different throughout the entire flight paths, or only at specific portions of the flight paths (e.g., intersect location 324, or the intersect location 324 plus a buffer zone, etc.).

### Example Flight Path Cross Sections

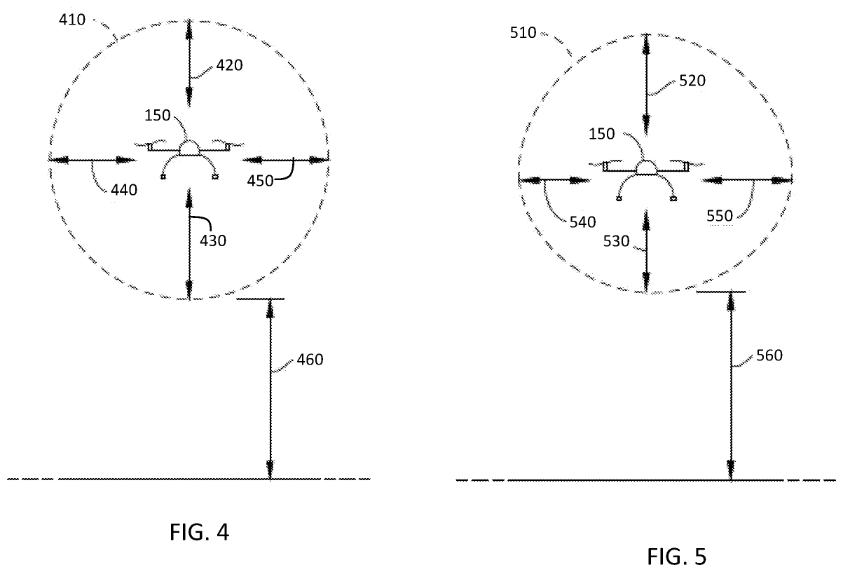

FIG. 4 illustrates an example flight path cross section with a circular cross section 410. In the example of FIG. 4, the cross section 410 is defined by vertical distance above the drone 420, vertical distance below the drone 430, horizontal distance from the left of the drone 440, and horizontal distance to the right of the drone 450. However, it should be understood that the dimensions of the cross section may be defined in any suitable way. For instance, if the cross section is circular, the cross section may be defined by a radius, a circumference, etc. The example of FIG. 4 further illustrates distance from the ground to the bottom edge of the circumference 460.

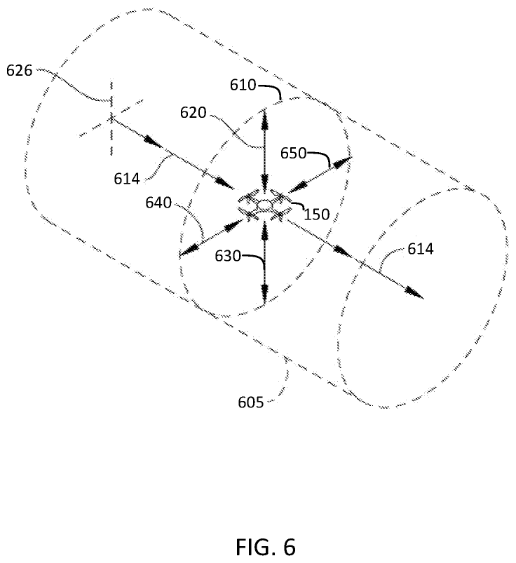

FIG. 5 illustrates an example flight path cross section with a noncircular cross section 510. In the example of FIG. 5, the cross section 510 is defined by vertical distance above the drone 520, vertical distance below the drone 530, horizontal distance from the left of the drone 540, and horizontal distance to the right of the drone 550. However, it should be understood that the dimensions of the cross section may be defined in any suitable way. The example of FIG. 5 further illustrates distance from the ground to the bottom edge of the circumference 560.

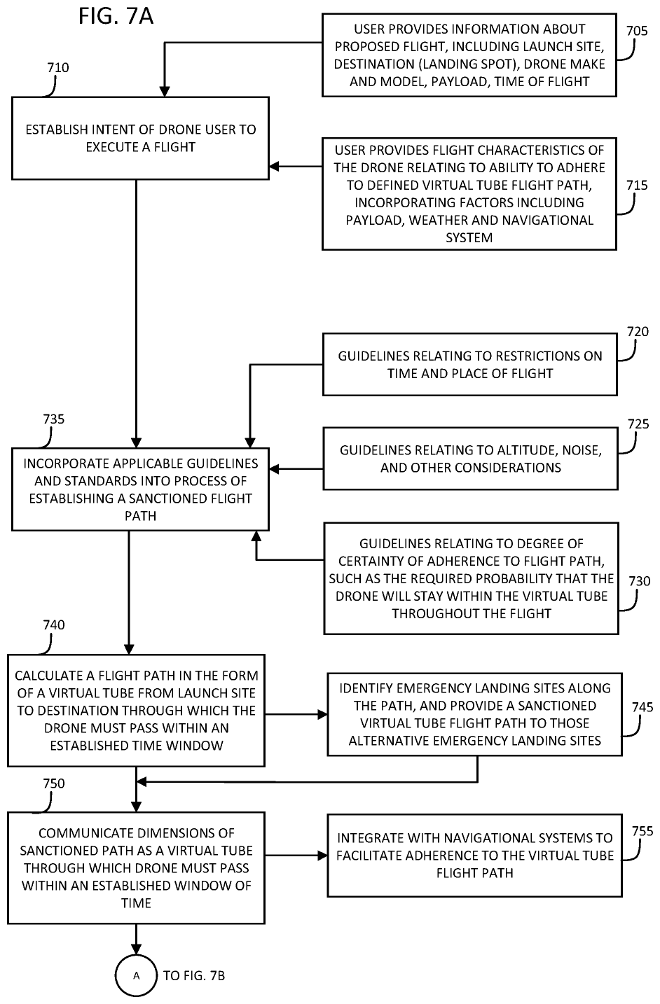

FIG. 6 is a 3-dimensional (3D) illustration of an example of a drone 150 in a virtual tube 605 (e.g., flight path). In the illustrated example of FIG. 6, the drone 150 starts at the start point 626, and travels along the direction of travel 614. The cross section 610 defines an area determined by the computing device 102 that the drone 150 is commanded to stay in. In this illustrated example, the cross section 610 is defined by vertical distance above the drone 620, vertical distance below the drone 630, horizontal distance from the left of the drone 640, and horizontal distance to the right of the drone 650. However, it should be understood that the dimensions of the cross section may be defined in any suitable way.

Furthermore, although the example of FIG. 6 illustrates a constant cross section 610 along the length of the virtual tube 605, it should be understood that the cross section may be larger or smaller at various portions of the virtual tube 605.

### Example Implementations

The process of establishing and communicating a sanctioned and safe flight path may be accomplished by integrating the relevant guidelines with the functional capability of the drone. The relevant guidelines may include information about where and when commercial drone traffic may traverse a given place. The guidelines may be established by industry groups or governmental entities or regulators, or a combination thereof. A proposed flight from a launching point to a landing point may be mapped in a manner that accommodates the restrictions imposed on commercial drone traffic, which may include restrictions on times of day, on place of flight (not over schools or hospitals or homes, etc.), on payload, or on speed and noise. The mapped path must also provide a margin of navigational safety. That is accomplished by provisioning a flight path using a virtual tube through space. That virtual tube may be calculated using the flight characteristics of the drone with its payload, accounting for weather, with a margin of safety that meets the applicable standards. For example, applicable guidelines may require that the virtual tube be large enough that, under expected conditions, the particular drone model with payload will stay within the tube a certain percentage of the time (for example, 99% certainty). And the virtual tube should be provisioned exclusively to the drone user for as long as needed to safely accommodate the flight. For example, as the drone passes along the flight path, the trailing portion of the flight path may be freed up for the use of another user. And the forward portion of the flight path may be exclusive for a portion of the full route that accommodates a reasonable margin of safety. The provisioned virtual tube should also provide for safe emergency landing scenarios—places along the path where the drone may safely land to terminate the flight. The virtual tube may be communicated to the drone user to enable the drone to traverse the path at the right speed and altitude at any point along the precise route. The flight may be tracked. Each flight may be recorded. The data relating to the flights may be reported to local authorities or regulators or other bodies for the purpose of monitoring adherence to the guidelines and assessing any fees or taxes relating to the flights. It may also be used to advise on best practices and the safe use of drones, including commercial drones.

Using a traditional web interface or app (e.g., on the drone controller 160), a user may request permission to execute a drone flight. That interface may require information pertinent to provisioning the flight path, including drone model, payload, navigational system, intended point of departure, intended point of landing, proposed time of departure, and expected time of landing. That request may be processed to establish a sanctioned flight path and flight path cross section (e.g., virtual tube). Calculation of a sanctioned flight path would optimize a flight path that adhered to restrictions on time, place, altitude and speed of flight. That flight path may be provisioned as a virtual tube that accommodates a designated margin of safety the ability of the drone to adhere to the flight path—taking into the consideration factors relating to the drone model, payload, navigational system and expected weather conditions. The designated margin of safety could be specified as a percentage likelihood that the drone would remain in the tube during the flight. For example, the tube could be enlarged such that the drone would be expected within a 99% certainty to be within it during the flight. The tube would be exclusive for a length necessary to provide a designated margin of safety. After the drone has passed through a given point in the tube, the airspace could be released for use by other drones. The sanctioned path will incorporate planned points of possible emergency landings—safe places along the path for the drone user to spontaneously terminate a flight. The virtual tube path will be communicated to the user in a manner that facilitates navigation, whether manual or automatic.

Execution of the flight may be tracked and recorded to facilitate the reuse of the airspace by other users, to assure adherence to the sanctioned path, to allow for fees or taxes to be assessed for the use of the airspace, and/or to provide analysis relating to the safe use of commercial drones.

Drone flights executed by commercial users present risks of nuisance and of threat to public safety. Using the described processes to establish a sanctioned flight path drastically diminishes these risks. The systems and methods described herein allow for rules and regulations or industry standards relating to commercial drone use to be enforced by being incorporated into the calculation of a sanctioned flight path, and allow for the collection of fees or taxes relating to the use of airspace and the administration of commercial drone use. Some implementations incorporate rules and regulations from multiple jurisdictional authorities, to implement controls specific to the place of use. Some implementations accommodate restrictions of any kind, including place of flight by time or altitude, speed of flight, decibel level, and margin of safety. This allows for any pertinent authority to facilitate the use of commercial drones while protecting the public interest.

Additionally, the process of provisioning a sanctioned flight path using a virtual tube may be incorporated into a computer system, such as the computing device 102. That system may calculate the sanctioned flight path, the designated margin of safety, and communicate the specifications of the path to the user. The system may track and record the flight for purposes of assuring adherence to the provisioned path, facilitating collection of fees or taxes, and for collecting data relating to the safe use of commercial drones.

Also, some embodiments create a platform for planning and executing any commercial drone service by commercial users, enabling users to adhere to standards, rules or regulations relating to safe and sanctioned use of commercial drones. That platform may facilitate logistics relating to commercial drones, enabling commercial drone users to operate services requiring drones to pass safely and legally through public space.

Furthermore, some embodiments create a basis of establishing property rights relating to sanctioned paths, whereby a commercial drone service could purchase rights to a given path from the applicable jurisdictional authorities.

Additionally, some embodiments create a basis of establishing navigational protocols used by drone users (whether manual or autonomous), and a basis for standardization of drone navigational protocols. The protocols may enable drone users to incorporate the dimensions of the sanctioned path into navigational systems and to enable tracking and recording of the flight.

### Example Methods for Determining a Flight Path and Cross Section

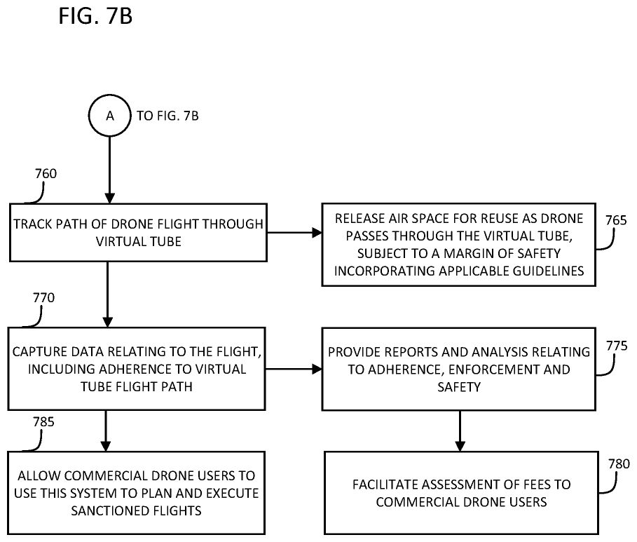

FIGS. 7A and 7B illustrate an example method of determining a flight path and a cross section of the flight path.

In some embodiments, the prerequisite to the flight is a request for a flight (e.g., from the drone 150 or drone controller 160 to the computing device 102). The computing device 102 may require the user (e.g., the drone 150 or the drone controller 160) to provide information about the proposed flight, including launching site, destination (landing) site, drone make and model (including alterations), and time of flight (block 705). The computing device 102 then establishes the intent of the drone (or drone user) to execute a flight based on the received information (block 710). Further based on the received information, the computing device 102 may establish a proposed point of departure and a proposed landing site, including for multiple leg flights.

The user may further provide flight characteristics of the drone 150 relating to the drone's ability to adhere to defined virtual tube flight path (e.g., incorporating factors such as payload, weather and navigational system) to the computing device (block 715). For example, the computing device 102 may require the user to specify the flight characteristics of the drone with and without its proposed payload to demonstrate the ability of the drone to adhere to a given flight path; and the computing device 102 may not determine a path for the drone 150 until this information is provided. This incorporates the navigational system planned to control the flight, whether manual or automated. The virtual tube provisioned by the system will be large enough to enable the drone to stay within the provisioned space (e.g., within the cross section) with a specific degree of certainty. That degree of certainty may be calculated based on the drone's flight characteristics and anticipated weather conditions at the time of flight. And the degree of certainty required by the jurisdiction may be a matter of public policy.

To this end, the computing device 102 may receive (e.g., from the government database 175, etc.): guidelines relating to restrictions on time and place of flight (block 720); guidelines relating to altitude, noise, and other considerations (block 725); and/or guidelines relating to degree of certainty of adherence to flight path, such as the required probability that the drone will stay within the virtual tube throughout the flight (block 730). The computing device 102 may incorporate applicable guidelines and standards to a process for determining a flight path (block 735) (e.g., these guidelines and/or other information may be input into a model and/or machine learning algorithm).

The computing device 102 may then calculate a flight path in the form of a virtual tube from launch site to destination through which the drone must pass within an established time window (block 740). In this regard, the system may establish a virtual tube from the proposed launching site to the proposed destination/landing site that traverses sanctioned air space. Sanctioned air space accommodates guidelines and restrictions established by industry groups or jurisdictional authorities to provide for safe use of drones. Those guidelines and restrictions may pertain to the time of flight, place of flight, altitude of flight, among other factors. They may prohibit flights over homes or schools or hospitals, for example, and may prohibit flights near critical infrastructure (such as power lines or utilities). The sanctioned flight path will guide the drone to its destination without breaching these restrictions. The flight path may be determined further based on the ability of drone 150 to adhere to the flight path, taking into consideration all relevant factors including type of drone, type of navigation (auto or manual, for example), weather conditions, payload and other metrics.

At block 745, the computing device 102 identifies emergency landing sites near the calculated flight path, and determines additional flight paths to guide the drone 150 from the calculated flight path to the emergency landing sites (e.g., to enable users to safely terminate a flight that cannot be completed).

At block 750, the computing device communicates the flight path (possibly including the additional flight paths to guide the drone 150 to the emergency landing sites) to the drone 150 and/or the drone controller 160. A time window in which the drone must traverse the flight path may also be included in the communication. In some embodiments, the time window comprises time and date of the availability of the sanctioned virtual tube flight path. Furthermore, there may be a time window for the user to launch the flight. Additionally or alternately, the computing device 102 may reserve the flight path for use by the drone 150 during any of the time windows and/or during the course of the drone's flight.

At block 755, the information received by the drone 150 and/or drone controller 160 may be incorporated into the navigational system (whether automated or manual) of the drone 150 and/or drone controller 160. In one example, the dimensions of the flight path and cross section are integrated into the automated navigational systems of the drone 150. Additionally or alternatively, communication (e.g., to the drone 150 and/or drone controller 160) may be in a manner that facilitates manual navigation adherent to the path.

At block 760, the computing device 102 tracks (e.g., through information received from the GPS 270) the drone flight through the virtual tube. This assures adherence to the designated right of way and to facilitate release of the designated air space. As the drone 150 traverses the path, the air space that it has passed may be released for the use of the system to provide a path to other users. Tracking the flight of the drone as it passes through the sanctioned virtual tube flight path may enable the system to safely release and reallocate that air space (block 765). The flight may be tracked to the point of its destination or landing.

At block 770, data is captured relating to the flight, including adherence to the virtual flight path. The data may include any data, such as GPS data taken from the GPS 270 and sent to the computing device 102 through the transmitter 240.

At block 775, the computing device 102 may provide reports and analysis relating to adherence, enforcement, and safety (e.g., to government regulators, to the government database 175, to jurisdictional authorities (such as municipalities), to industry regulators, to other regulators, etc.). The reporting may be dictated by jurisdictional authorities, including for the purpose of collecting fees and/or taxes. The reports may also be used to advise on the safe and efficient use of drones.

At block 780, fees may be assessed to the drone 150 and/or owner of the drone 150. The fees may be assessed by the computing device 102 and/or any other entity, such as a government entity, a jurisdictional authority, etc.

At block 785, drone users (e.g., commercial drone users) may be allowed to use the system to plan and execute further drone flights.

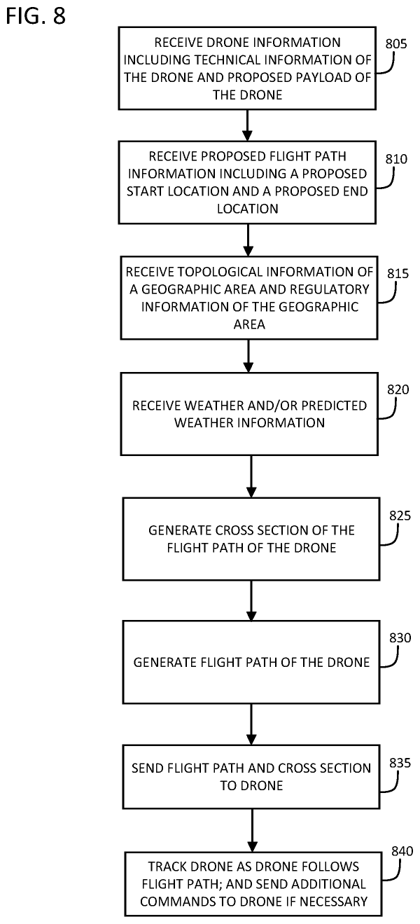

FIG. 8 illustrates another example method of determining a flight path and a cross section of the flight path. At block 805, drone information is received (e.g., by the computing device 102 from the drone 150, the drone controller 160, and/or the drone manufacturer database 170, etc.). The drone information may include technical information of the drone and/or a proposed payload of the drone. The technical information of the drone may include information of the drone's ability to stay within a cross section of a flight path. Additionally or alternatively, the technical information of the drone may include battery power/consumption information of the drone, a listing of technical components of the drone, sensor information (e.g. type of sensors, sensor capabilities, etc.), speed information, acceleration information, maneuverability information, information of the drone's capability to handle particular weather, noise information of the drone or of particular components of the drone, make of the drone, model of the drone, etc.

The proposed payload information of the drone may include any kind of payload information. For example, the payload information may include weight of the payload, shape of the payload, materials that the payload is made of, etc.

At block 810, proposed flight path information is received (e.g., by the computing device 102 from the drone 150 and/or the drone controller 160). The flight path information may include any information. For example, the flight path information may include a proposed start location, a proposed end location, a proposed start time, a proposed end time, a proposed number of stops, a proposed altitude, a proposed flight path, etc.

At block 815, topological information of a geographic area and/or regulatory information of the geographic area is received (e.g., by the computing device 102 from the geographical database 180 and/or the government database 175). The topological information of the geographic area may include any information. For example, the topological information of the geographic area may include map information, structure information (e.g., dimensional information of structures in the geographic area), elevation data of the geographic area, etc.

The regulatory information of the geographic area may include any information. For example, the regularity information may include government regulations of drones (e.g., time and location types of drones are allowed to fly, etc.), tax information, fee (e.g., tolls, etc.) information, restrictions on various types of drones due to weather or predicted weather conditions, payload weight regulations, other payload regulations (e.g., what types of goods may be transported through what areas), etc.

At block 820, weather information and/or predicted weather information is received (e.g., by the computing device 102 from the weather database 190). The weather information and/or predicted weather information may include any information. For example, the weather information and/or predicted weather information may include temperature information, climate information, precipitation information, snowfall information, humidity information, natural disaster (e.g., tornado, hurricane, tsunami, earthquake, etc.) information, wind speed information, etc.

At block 825, the computing device 102 generates the cross section of the flight path. For example, the cross section may be generated base on: the technical information of the drone, the proposed payload, drone make and/or model, weather information, predicted weather information (e.g., including time information of when the weather is predicted to occur), the proposed start and finish times of the flight, and/or government regulations (e.g., of how far apart drones are required to be, etc.), etc.

The cross section may be generated by any suitable technique. For example, the cross section may be generated by inputting any of the information that the cross section is generated based on into a machine learning algorithm (e.g., a neural network, a random forest, a reinforcement learning algorithm, a gradient boosting algorithm, etc.). The machine learning algorithm may have been trained by any suitable technique (e.g., supervised learning, unsupervised learning, semi-supervised learning). The machine learning algorithm may have been trained by any suitable component (e.g., the machine learning training application 128, etc.). Alternatively, the cross section may be generated without a machine learning algorithm. For example, the cross section may be determined simply from the above-mentioned information by using lookup tables or mathematical equations; or simply by receiving the cross section (or suggested cross section) from an outside source (e.g., the drone manufacturer database 170 and/or government database 175).

At block 830, the computing device 102 generates the flight path. The flight path may be generated based on any information described herein. For example, the flight path may be generated based on the proposed start location, the proposed end location, the technical information of the drone, the proposed payload of the drone, other scheduled flight paths, dedicated flight paths for other drones, the topological information, the regulatory information, no fly zone information, other zoning information, noise regulations, noise levels of the drone, emergency site location information, emergency site capacity information, emergency site terrain information, toll information, tax information, fee information, and/or safe distance information of other drones, etc.

The flight path may be generated by any suitable technique. For example, the flight path may be generated by inputting any of the information that the flight path is generated based on into a machine learning algorithm (e.g., a neural network, a random forest, a reinforcement learning algorithm, a gradient boosting algorithm, etc.). The machine learning algorithm may have been trained by any suitable technique (e.g., supervised learning, unsupervised learning, semi-supervised learning). The machine learning algorithm may have been trained by any suitable component (e.g., the machine learning training application 128, etc.). Alternatively, the flight path may be generated without a machine learning algorithm. For example, the flight path may be determined simply from the above-mentioned information by using mathematical equations and or algorithms (e.g., to minimize the distance between the proposed start and end locations while accounting for other factors); or simply by receiving the flight path (or suggested flight path) from an outside source (e.g., the government database 175 or any other source).

In some embodiments, the flight path may be generated at least in part based on a probability or probabilities. For example, based on the technical information of the drone 150 and the predicted weather information, the computing device 102 may calculate a probability that the drone will sustain damage in the predicted weather. If the probability is greater than a threshold, the computing device may generate an alternate flight path to avoid the predicted weather, and/or set a different time window for the drone 150 to travel in, etc.

At block 835, the computing device 102 sends the flight path and cross section to the drone 150 and/or the drone controller 160. The computing device 102 may further send toll, tax, and fee information along with the flight path and cross section. Additionally or alternatively, the computing device 102 may send a time window for the drone to traverse the flight path along with sending the flight path and cross section.

At block 840, the computing device 102 tracks the drone 150 as the drone 150 follows the flight path (e.g., by receiving information from the GPS 270 of the drone 150 or by any other suitable technique), and sends additional commands to the drone 150 if necessary.

For example, the computing device 102 may determine that the drone 150 has deviated from the flight path that it was sent; and, in response, the computing device 102 may send a command (and/or warning) to the drone 150 and/or drone controller 160 to return to the flight path. Additionally or alternatively in response to the determination, the computing device 102 may command the drone 150 to land at an emergency landing site. Additionally or alternatively in response to the determination, the computing device 102 may take over control of the drone 150 (e.g., to fly the drone 150 back to the flight path, or to an emergency landing site, etc.).

In another example, the computing device 102 may determine the drone 150 has deviated from the flight path a predetermined number of times during a predetermined time period; and, in response, take any appropriate action, including those described above. For example, in response, the computing device 102 may command the drone 150 to land at an emergency landing site.

It may be noted that the deviation(s) from the flight path may be due to any cause. For example, the deviation(s) may be due to the collision avoidance system 280 commanding the drone 150 to maneuver to avoid collision with another drone. Additionally or alternatively, the deviation(s) may be due to strong winds or other weather conditions, etc.

Furthermore, once the drone 150 has begun to traverse the flight path, the drone 150 may determine that an emergency landing is required (e.g., the drone 150 determines a low battery condition, a high temperature condition, a problem with its payload, etc.). In such a situation, the drone 150 may request to land at an emergency landing site; and the computing device 102 may determine an appropriate landing site, and send the emergency landing site information to the drone 150.

In another example, subsequent to the drone 150 beginning to traverse the flight path, the computing device 102 may determine a new predicted weather condition. The computing device may then determine a probability that the drone 150 will sustain damage (e.g., based on the technical information of the drone 150 and the new predicted weather condition); and, if the probability is greater than a threshold, command the drone 150 to land an emergency landing site, or take another course of action (e.g., changing altitude to avoid high winds, changing the cross section to avoid collision with other drones in high wind conditions, etc.).

It may be noted that the example methods illustrated in FIGS. 7A-7B and 8 may be iterative. For example, once the example process of FIG. 8 is completed for a first drone, the process may iterate to be performed on a second drone. In this way, when the process is performed on the second drone, the flight path of the second drone may be calculated such that the flight path of the second drone avoids the flight path of the first drone.

Further regarding the example flowcharts provided above, it should be noted that all blocks are not necessarily required to be performed. Moreover, additional blocks may be performed although they are not specifically illustrated in the example flowcharts. In addition, the example flowcharts are not mutually exclusive. For example, block(s) from one example flowchart may be performed in another of the example flowcharts.

### Additional Exemplary Embodiments

Aspect 1. A computer-implemented method for generating a flight path of a drone, the method comprising:

receiving, with one or more processors, drone information including technical information of the drone, and a proposed payload of the drone;

receiving, with the one or more processors, proposed flight path information including a proposed start location, and a proposed end location;

generating, with the one or more processors, a cross section of the flight path based on the technical information of the drone, and the proposed payload of the drone;

generating, with the one or more processors, the flight path based on the proposed start location, and the proposed end location; and

sending, with the one or more processors, the flight path and the cross section of the flight path to the drone.

Aspect 2. The computer-implemented method of aspect 1, wherein the technical information of the drone includes information of the drone's ability to stay within a cross-sectional area of a given flight path.

Aspect 3. The computer-implemented method of any one of aspects 1-2, further comprising:

receiving, with the one or more processors, a proposed travel start time;

receiving, with the one or more processors, predicted weather information corresponding to the proposed start time; and

wherein the generating of the cross section of the flight path comprises generating the cross section further based on the predicted weather information; and

wherein the generating of the flight path further comprises generating the flight path further based on the predicted weather information.

Aspect 4. The computer-implemented method of any one of aspects 1-3, further comprising:

receiving, with the one or more processors, a noise regulation level of a geographic area; and

wherein the including technical information of the drone further includes a noise level of the drone; and

wherein the generating of the flight path further comprises generating the flight path further based on: (i) the noise regulation level of the geographic area, and (ii) the noise level of the drone.

Aspect 5. The computer-implemented method of any one of aspects 1-4, further comprising, subsequent to the sending of the flight path and the cross section of the flight path to the drone:

determining, with the one or more processors, that the drone has started to travel according to the flight path;

determining, with the one or more processors, that the drone has deviated from the flight path; and

in response to the determination that the drone has deviated from the flight path, commanding, with the one or more processors, the drone to land at an emergency landing site.

Aspect 6. The computer-implemented method of any one of aspects 1-5, further comprising:

receiving, with the one or more processors and from the drone, a request to complete an emergency landing;

in response to receiving a request to complete the emergency landing, with the one or more processors, determining an emergency landing site based on: (i) a current location of the drone; (ii) locations of predetermined emergency landing sites, and (iii) availability of the predetermined emergency landing sites; and

sending, with the one or more processors to the drone, location information of the determined emergency landing site.

Aspect 7. The computer-implemented method of any one of aspects 1-6, further comprising:

sending, with the one or more processors, information of a toll, tax, or fee based on the generated flight path to the drone.

Aspect 8. The computer-implemented method of any one of aspects 1-7, wherein:

the flight path is a first flight path, the drone is a first drone, the drone information is first drone information, the proposed flight path information is first proposed flight path information; and

the method further comprises:

receiving, with the one or more processors, second drone information including technical information of the second drone, and a proposed payload of the second drone;

receiving, with the one or more processors, second proposed flight path information including a proposed start location, and a proposed end location;

generating, with the one or more processors, a cross section of a second flight path based on the technical information of the second drone, and the proposed payload of the second drone;

generating, with the one or more processors, the second flight path based on the proposed start location, and the proposed end location;

determining, with the one or more processors, that the first flight path intersects with the second flight path;

determining that the proposed payload of the first drone is heavier than the proposed payload of the second drone;

in response to both the determination that the first flight path intersects with the second flight path, and the determination that the payload of the first drone is heavier than the payload of the second drone, modifying the second flight path to be at a higher altitude than the first flight path; and

sending, with the one or more processors, the modified second flight path to the second drone.

Aspect 9. The computer-implemented method of any one of aspects 1-8, wherein the generating of the cross section of the flight path comprises inputting, into a trained machine learning algorithm, the received technical information of the drone.

Aspect 10. The computer-implemented method of any one of aspects 1-9, further comprising:

receiving, with the drone, the flight path and the cross section of the flight; and

flying the drone according to the flight path and the cross section of the flight path.

Aspect 11. A device for generating a flight path of a drone, the device comprising one or more processors configured to:

receive: (i) topological information of a geographic area, and (ii) regulatory information of the geographic area;

receive proposed flight path information including a proposed start location, and a proposed end location;

generate the flight path of the drone based on: (i) the proposed start location, (ii) the proposed end location, (iii) the topological information, and (iv) the regulatory information of the geographic area; and send the generated flight path to the drone.

Aspect 12. The device of aspect 11, wherein the one or more processors are further configured to:

receive technical information of the drone;

generate a cross section of the flight path based on the received technical information of the drone; and

send the cross section of the flight path to the drone.

Aspect 13. The device of any one of aspects 11-12, wherein the one or more processors are further configured to:

receive make and model information of the drone;

generate a cross section of the flight path based on the received make and model information of the drone; and

send the cross section of the flight path to the drone.

Aspect 14. The device of any one of aspects 11-13, wherein the one or more processors are further:

configured to determine a no fly zone from the received regulatory information of the geographic area, wherein the no fly zone includes a hospital zone, a school zone, a residential zone, and/or a protected zone; and

generate the flight path such that the flight path does not intersect with the no fly zone.

Aspect 14a. The device of any one of aspects 11-13, wherein the one or more processors are further:

configured to determine: (i) a no fly zone from the received regulatory information of the geographic area, wherein the no fly zone includes a hospital zone, a school zone, a residential zone, and/or a protected zone, and (ii) a time window of the no fly zone; and

generate the flight path such that the flight path does not intersect with the no fly zone during the time window of the no fly zone.

Aspect 15. The device of any one of aspects 11-14, wherein the one or more processors are further configured to:

determine that the drone has started to travel according to the flight path;

receive predicted weather information;

receive technical information of the drone;

determine a probability that the drone will sustain damage due to possible upcoming weather based on: (i) the predicted weather information, and (ii) the received technical information of the drone;

if the probability is greater than a predetermined threshold, determine an emergency landing site based on: (i) a current location of the drone; (ii) locations of predetermined emergency landing sites, and (iii) availability of the predetermined emergency landing sites; and

send, to the drone, location information of the determined emergency landing site.

Aspect 16. The device of any one of aspects 11-15, wherein the drone is a first drone, and the one or more processors are further configured to:

receive technical information of the first drone;

determine, based on the received technical information, a safe distance from the first drone, the safe distance extending from a rear of the first drone along a portion of the flight path that the first drone has already traveled along; and

determine a flight path of a second drone based on the determined safe distance.

Aspect 17. The device of any one of aspects 11-16, wherein the one or more processors are further configured to:

determine, based on generated flight paths of other drones, a time window in which the drone may travel along the flight path; and

send the time window to the drone.

Aspect 18. The device of any one of aspects 11-17, wherein the one or more processors are further configured to generate the flight path of the drone by inputting, into a trained machine learning algorithm: (i) the proposed start location, (ii) the proposed end location, (iii) the topological information, (iv) the regulatory information of the geographic area, and (v) information of flight paths of other drones.

Aspect 18a. The device of any one of aspects 11-18, wherein the one or more processors are further configured to generate the flight path of the drone further based on avoiding a dedicated flight path of a dedicated flight path drone.

Aspect 19. A drone comprising:

a drone body;

a plurality of propulsion devices connected to the drone body;

a drone transmitter, and a drone receiver comprised in the drone body; and

one or more drone processors configured to:
send, via the drone transmitter, drone information including technical information of the drone, and a proposed payload of the drone;
send, via the drone transmitter, proposed flight path information including a proposed start location, and a proposed end location;
receive, via the drone receiver, a cross section of a flight path, wherein the cross section of the flight path was generated based on the technical information of the drone, and the proposed payload of the drone;
receive, via the drone receiver, the flight path, wherein the flight path was generated based on the proposed start location, and the proposed end location; and
control, via the plurality of propulsion devices, the drone to fly: (i) according to the received flight path, and (ii) within the received cross section of the flight path.

Aspect 20. The drone of aspect 19, further comprising:

a global positioning system (GPS) device configured to determine a location of the drone;

a collision avoidance system including at least one proximity sensor; and

wherein the one or more drone processors are configured to:

determine if the drone has deviated from the flight path a predetermined number of times during a predetermined time period; and

if the drone has deviated from the flight path the predetermined number of times during the predetermined time period, control the drone to land at an emergency landing site.

Aspect 21. The drone of any one of aspects 19-20, wherein the plurality of propulsion devices comprises at least one propeller and/or at least one impeller.

### OTHER MATTERS

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Furthermore, the patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed:

1. A computer-implemented method for generating a flight path of a drone, the method comprising:
receiving, with one or more processors, drone information including technical information of the drone, and a proposed payload of the drone;
receiving, with the one or more processors, proposed flight path information including a proposed start location, and a proposed end location;
generating, with the one or more processors, a cross section of the flight path based on the technical information of the drone, and the proposed payload of the drone;
generating, with the one or more processors, the flight path based on the proposed start location, and the proposed end location; and
sending, with the one or more processors, the flight path and the cross section of the flight path to the drone.

2. The computer-implemented method of claim 1, wherein the technical information of the drone includes information of the drone's ability to stay within a cross-sectional area of a given flight path.

3. The computer-implemented method of claim 1, further comprising:
receiving, with the one or more processors, a proposed travel start time;
receiving, with the one or more processors, predicted weather information corresponding to the proposed start time; and
wherein the generating of the cross section of the flight path comprises generating the cross section further based on the predicted weather information; and
wherein the generating of the flight path further comprises generating the flight path further based on the predicted weather information.

4. The computer-implemented method of claim 1, further comprising:
receiving, with the one or more processors, a noise regulation level of a geographic area; and
wherein the including technical information of the drone further includes a noise level of the drone; and
wherein the generating of the flight path further comprises generating the flight path further based on: (i) the noise regulation level of the geographic area, and (ii) the noise level of the drone.

5. The computer-implemented method of claim 1, further comprising, subsequent to the sending of the flight path and the cross section of the flight path to the drone:
determining, with the one or more processors, that the drone has started to travel according to the flight path;
determining, with the one or more processors, that the drone has deviated from the flight path; and
in response to the determination that the drone has deviated from the flight path, commanding, with the one or more processors, the drone to land at an emergency landing site.

6. The computer-implemented method of claim 1, further comprising:
receiving, with the one or more processors and from the drone, a request to complete an emergency landing;
in response to receiving a request to complete the emergency landing, with the one or more processors, determining an emergency landing site based on: (i) a current location of the drone; (ii) locations of predetermined emergency landing sites, and (iii) availability of the predetermined emergency landing sites; and
sending, with the one or more processors to the drone, location information of the determined emergency landing site.

7. The computer-implemented method of claim 1, further comprising:
sending, with the one or more processors, information of a toll, tax, or fee based on the generated flight path to the drone.

8. The computer-implemented method of claim 1, wherein:
the flight path is a first flight path, the drone is a first drone, the drone information is first drone information, the proposed flight path information is first proposed flight path information; and
the method further comprises:
receiving, with the one or more processors, second drone information including technical information of the second drone, and a proposed payload of the second drone;
receiving, with the one or more processors, second proposed flight path information including a proposed start location, and a proposed end location;
generating, with the one or more processors, a cross section of a second flight path based on the technical information of the second drone, and the proposed payload of the second drone;
generating, with the one or more processors, the second flight path based on the proposed start location, and the proposed end location;
determining, with the one or more processors, that the first flight path intersects with the second flight path;
determining that the proposed payload of the first drone is heavier than the proposed payload of the second drone;
in response to both the determination that the first flight path intersects with the second flight path, and the determination that the payload of the first drone is heavier than the payload of the second drone, modifying the second flight path to be at a higher altitude than the first flight path; and
sending, with the one or more processors, the modified second flight path to the second drone.

9. The computer-implemented method of claim 1, wherein the generating of the cross section of the flight path comprises inputting, into a trained machine learning algorithm, the received technical information of the drone.

10. The computer-implemented method of claim 1, further comprising:
receiving, with the drone, the flight path and the cross section of the flight; and
flying the drone according to the flight path and the cross section of the flight path.

11. A device for generating a flight path of a drone, the device comprising one or more processors configured to:
receive: (i) topological information of a geographic area, and (ii) regulatory information of the geographic area;
receive proposed flight path information including a proposed start location, and a proposed end location;
generate the flight path of the drone based on: (i) the proposed start location, (ii) the proposed end location, (iii) the topological information, and (iv) the regulatory information of the geographic area; and
send the generated flight path to the drone.

12. The device of claim 11, wherein the one or more processors are further configured to:
receive technical information of the drone;
generate a cross section of the flight path based on the received technical information of the drone; and
send the cross section of the flight path to the drone.

13. The device of claim 11, wherein the one or more processors are further configured to:
receive make and model information of the drone;
generate a cross section of the flight path based on the received make and model information of the drone; and
send the cross section of the flight path to the drone.

14. The device of claim 11, wherein the one or more processors are further:
configured to determine a no fly zone from the received regulatory information of the geographic area, wherein the no fly zone includes a hospital zone, a school zone, a residential zone, and/or a protected zone; and
generate the flight path such that the flight path does not intersect with the no fly zone.

15. The device of claim 11, wherein the one or more processors are further configured to:
determine that the drone has started to travel according to the flight path;
receive predicted weather information;
receive technical information of the drone;
determine a probability that the drone will sustain damage due to possible upcoming weather based on: (i) the predicted weather information, and (ii) the received technical information of the drone;
if the probability is greater than a predetermined threshold, determine an emergency landing site based on: (i) a current location of the drone; (ii) locations of predetermined emergency landing sites, and (iii) availability of the predetermined emergency landing sites; and
send, to the drone, location information of the determined emergency landing site.

16. The device of claim 11, wherein the drone is a first drone, and the one or more processors are further configured to:
receive technical information of the first drone;
determine, based on the received technical information, a safe distance from the first drone, the safe distance extending from a rear of the first drone along a portion of the flight path that the first drone has already traveled along; and
determine a flight path of a second drone based on the determined safe distance.

17. The device of claim 11, wherein the one or more processors are further configured to:
determine, based on generated flight paths of other drones, a time window in which the drone may travel along the flight path; and
send the time window to the drone.

18. The device of claim 11, wherein the one or more processors are further configured to generate the flight path of the drone by inputting, into a trained machine learning algorithm: (i) the proposed start location, (ii) the proposed end location, (iii) the topological information, (iv) the regulatory information of the geographic area, and (v) information of flight paths of other drones.

19. A drone comprising:
a drone body;
a plurality of propulsion devices connected to the drone body;
a drone transmitter, and a drone receiver comprised in the drone body; and
one or more drone processors configured to:
send, via the drone transmitter, drone information including technical information of the drone, and a proposed payload of the drone;
send, via the drone transmitter, proposed flight path information including a proposed start location, and a proposed end location;
receive, via the drone receiver, a cross section of a flight path, wherein the cross section of the flight path was generated based on the technical information of the drone, and the proposed payload of the drone;
receive, via the drone receiver, the flight path, wherein the flight path was generated based on the proposed start location, and the proposed end location; and
control, via the plurality of propulsion devices, the drone to fly: (i) according to the received flight path, and (ii) within the received cross section of the flight path.

20. The drone of claim 19, further comprising:
a global positioning system (GPS) device configured to determine a location of the drone;
a collision avoidance system including at least one proximity sensor; and
wherein the one or more drone processors are configured to:
determine if the drone has deviated from the flight path a predetermined number of times during a predetermined time period; and
if the drone has deviated from the flight path the predetermined number of times during the predetermined time period, control the drone to land at an emergency landing site.
